(19) United States
(12) Patent Application Publication
(10) Pub. No.: US 2026/0062970 A1
(43) Pub. Date: Mar. 5, 2026

(54) Gate-Securing Device

(71) Applicant: John D. Logan, JR., Memphis, TN (US)

(72) Inventor: John D. Logan, JR., Memphis, TN (US)

(21) Appl. No.: 19/291,751

(22) Filed: Aug. 6, 2025

Related U.S. Application Data
(60) Provisional application No. 63/687,328, filed on Aug. 27, 2024.

(51) Int. Cl. E05C 17/56; E05F 5/08

(52) U.S. Cl. CPC E05C 17/56; E05F 5/08

(57) ABSTRACT

A gate-securing device is provided. The device is designed to maintain gates in an open position through a combination of a magnetic locking mechanism and a spring-based impact absorption system. The device comprises a first magnet assembly mounted on the gate and a second magnet assembly secured to the ground, ensuring reliable connection through opposite polarity. The first assembly includes a heavy-duty magnet affixed via a weather-resistant mounting bracket, which offers adjustable positioning for alignment. The second assembly incorporates a second magnet with a compression spring that absorbs impact forces when the gate opens, reducing mechanical stress and facilitating smooth disengagement. The second assembly is mounted on a ground fastener, which can be adjustable for height and secured into various surfaces. A method of use involves swinging the gate open to connect the magnets, with the spring providing flexibility for disengagement.

### CROSS-REFERENCE TO RELATED APPLICATION

The present application claims priority to, and the benefit of, U.S. Provisional Application No. 63/687,328, which was filed on Aug. 27, 2024, and is incorporated herein by reference in its entirety.

### FIELD OF THE INVENTION

The present invention relates generally to the field of gates. More specifically, the present invention relates to a device that uses a magnetic locking mechanism and a spring-based impact absorption system, comprising a first magnet assembly on the gate and a second magnet assembly with a spring mounted on an adjustable ground fastener to maintain gates in the open position. When the gate is swung open while the device is in use, the magnets connect securely, and the spring absorbs impact forces and allows for smooth disengagement. Accordingly, the present disclosure makes specific reference thereto. Nonetheless, it is to be appreciated that aspects of the present invention are also equally applicable to other like applications, devices, and methods of manufacture.

### BACKGROUND

Gates and fences are common installations in residential, commercial, and industrial settings, providing security and boundary definition. However, when gate doors need to remain open, users typically rely on latches, ties, or rudimentary props. These traditional solutions are often unreliable, as they can fail to keep the gate securely open, especially in the presence of wind or slight inclines. When a gate slams shut unexpectedly, it can result in damage to nearby vehicles, structures, fences, or the gate itself. This problem becomes more pronounced in areas where gates are frequently used, leading to repeated impact damage, costly repairs, and safety hazards. Furthermore, sudden gate closure due to wind or gravity can pose risks to people or animals passing through. This issue highlights the need for a robust, reliable mechanism that can securely hold gates open without relying on inefficient methods. The challenge is to design a solution that accommodates different gate sizes and ensures secure, yet easily releasable, gate retention.

Therefore, there exists a long-felt need in the art for a gate-securing device that provides a reliable means of keeping gates open without using traditional latches or ties. There also exists a long-felt need in the art for a gate-securing device that accommodates both large and small gates while ensuring a secure hold. Moreover, there exists a long-felt need in the art for a gate-securing device that minimizes the potential for impact damage caused by gates slamming shut due to wind or gravity.

The subject matter disclosed and claimed herein, in one embodiment thereof, comprises a gate-securing device. The device is designed to maintain gates in an open position through a combination of a magnetic locking mechanism and a spring-based impact absorption system. The device comprises a first magnet assembly mounted on the gate and a second magnet assembly secured to the ground, ensuring reliable connection through opposite polarity. The first assembly includes a heavy-duty magnet affixed via a weather-resistant mounting bracket, which offers adjustable positioning for alignment. The second assembly incorporates a second magnet with a compression spring that absorbs impact forces when the gate opens, reducing mechanical stress and facilitating smooth disengagement. The second assembly is mounted on a ground fastener, which can be adjustable for height and secured into various surfaces. A method of use involves swinging the gate open to connect the magnets, with the spring providing flexibility for disengagement.

In this manner, the gate-securing device of the present invention accomplishes all the foregoing objectives and provides a device for holding gates open securely using magnets and a spring mechanism to absorb the force of contact and ensure ease of release. As a result, the device effectively prevents gates from slamming shut, thereby reducing the risk of damage to vehicles, structures, and fences. This design provides a dependable and adaptable solution to the long-standing issue of gate retention, ensuring safety, reliability, and ease of use for various gate types.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a gate-securing device. The gate-securing device is designed to hold gates securely in the open position using a magnetic locking mechanism combined with a spring-based impact absorption system. This design minimizes the risk of sudden gate closures caused by external forces, reducing potential damage to vehicles, buildings, or fences.

The device includes a first magnet assembly, comprising at least one first magnet and one mounting bracket. The first magnet is a heavy-duty magnet for outdoor use, generating a strong magnetic field to maintain a secure hold under varying environmental conditions. The mounting bracket is made from weather-resistant materials such as stainless steel or powder-coated steel and includes multiple pre-drilled holes for attachment to gates made of wood, metal, or vinyl. The bracket is adjustable, allowing vertical and horizontal positioning to align with the second magnet.

The second magnet assembly consists of at least one second magnet, one spring, and one ground fastener. The second magnet forms a secure connection with the first magnet through opposite polarity, holding the gate in the open position. A compression-type spring behind the second magnet absorbs impact forces when the gate swings open, reducing mechanical stress and facilitating the disengagement of the magnets with a manual pull.

The second magnet and spring assembly is mounted to a ground fastener made from heavy-duty galvanized steel for corrosion resistance. The ground fastener may include a pointed spike for soil insertion or be telescopic to adjust the height of the second magnet for alignment with the first magnet. A locking mechanism secures the ground fastener at the desired height.

To operate the device, the gate is swung open until the first magnet contacts the second magnet, compressing the spring and establishing a secure connection. The gate remains open until manually closed. A gentle pull releases the magnets, with the spring easing the disengagement.

The device provides effective impact absorption, extending the system's lifespan. The adjustable mounting bracket and ground fastener facilitate installation with various gate types and ground conditions. Weather-resistant materials enhance durability and reliability in outdoor environments.

The invention also includes a method of using the gate-securing device. The method involves attaching the first magnet assembly to the gate, securing the second magnet assembly to the ground fastener, aligning the magnets, and swinging the gate open until the magnets connect. The gate remains open until manually closed, and disengagement is achieved with a pull assisted by the spring.

Accordingly, the gate-securing device of the present invention is particularly advantageous as it provides a device for holding gates open securely using magnets and a spring mechanism to absorb the force of contact and ensure ease of release. As a result, the device effectively prevents gates from slamming shut, thereby reducing the risk of damage to vehicles, structures, and fences. This design provides a dependable and adaptable solution to the long-standing issue of gate retention, ensuring safety, reliability, and ease of use for various gate types.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a gate-securing device of the present invention while the first magnet and second magnet are unattached in accordance with the disclosed architecture;

FIG. 2 illustrates a perspective view of one potential embodiment of a gate-securing device of the present invention while the first magnet and second magnet are attached in accordance with the disclosed architecture; and

FIG. 3 illustrates a flowchart of a method of using one potential embodiment of a gate-securing device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a gate-securing device that provides a reliable means of keeping gates open without using traditional latches or ties. There also exists a long-felt need in the art for a gate-securing device that accommodates both large and small gates while ensuring a secure hold. Moreover, there exists a long-felt need in the art for a gate-securing device that minimizes the potential for impact damage caused by gates slamming shut due to wind or gravity.

The present invention, in one exemplary embodiment, is comprised of a gate-securing device. The gate-securing device holds gates securely in the open position using a magnetic locking mechanism combined with a spring-based impact absorption system. This design minimizes the risk of sudden gate closures caused by external forces, reducing potential damage to vehicles, buildings, or fences.

The device includes a first magnet assembly, comprising at least one first magnet and a mounting bracket. The first magnet is a heavy-duty outdoor magnet that generates a strong magnetic field to maintain a secure hold under varying environmental conditions. The mounting bracket is made from weather-resistant materials such as stainless steel or powder-coated steel and features multiple pre-drilled holes for attachment to gates made of wood, metal, or vinyl. The bracket is adjustable, allowing for vertical and horizontal positioning to align with the second magnet.

The second magnet assembly comprises at least one second magnet, a spring, and a ground fastener. The second magnet forms a secure connection with the first magnet through opposite polarity, keeping the gate in the open position. A compression-type spring positioned behind the second magnet absorbs impact forces when the gate swings open, reducing mechanical stress and facilitating the magnets' disengagement with a manual pull.

The second magnet and spring assembly is attached to a ground fastener made from heavy-duty galvanized steel for corrosion resistance. The ground fastener may feature a pointed spike for soil insertion or a telescopic mechanism to adjust the second magnet's height for proper alignment with the first magnet. A locking mechanism maintains the ground fastener at the desired height.

To operate the device, the gate is swung open until the first magnet contacts the second magnet, compressing the spring and establishing a secure connection. The gate remains open until manually closed. A gentle pull releases the magnets, with the spring assisting in the disengagement.

The device effectively absorbs impact forces, extending its lifespan. The adjustable mounting bracket and ground fastener simplify installation for various gate types and ground conditions. Weather-resistant materials enhance durability and reliability in outdoor settings.

The invention also includes a method for using the gate-securing device. The method involves attaching the first magnet assembly to the gate, securing the second magnet assembly to the ground fastener, aligning the magnets, and swinging the gate open until the magnets connect. The gate remains open until manually closed, and disengagement is achieved with a pull assisted by the spring.

The gate-securing device provides a reliable solution for holding gates open securely, using magnets and a spring mechanism to absorb impact and ensure easy release. This design effectively prevents gates from slamming shut, reducing the risk of damage to vehicles, structures, and fences. The device offers a dependable, adaptable, and user-friendly solution for various gate types, ensuring safety and ease of use.

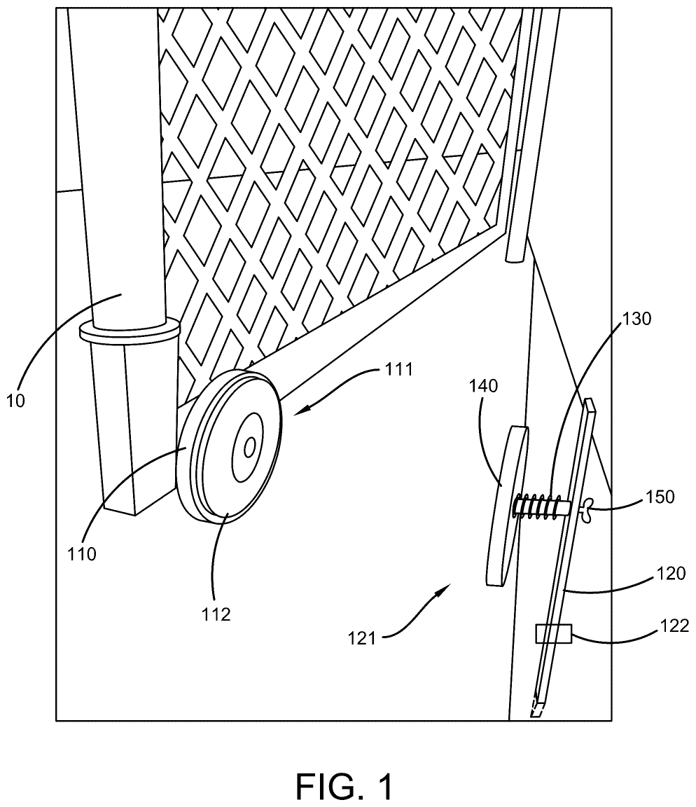

Referring initially to the drawings, FIG. 1 illustrates a perspective view of one potential embodiment of a gate-securing device 100 of the present invention while the first magnet 112 and second magnet 140 are unattached in accordance with the disclosed architecture. The gate-securing device 100 is designed to hold gates 10 securely in the open position using a magnetic locking mechanism combined with a spring-based impact absorption system. This design minimizes the risk of sudden gate closures caused by wind, gravity, or external forces, thereby reducing potential damage to vehicles, buildings, or fences.

The first key component of the device 100 is at least one first magnet assembly 111, which includes at least one first magnet 112 and at least one mounting bracket 110. The first magnet 112 is preferably, but not limited to, a heavy-duty magnet specifically designed for outdoor use, generating a strong magnetic field that maintains a secure hold even under varying environmental conditions, such as exposure to moisture, temperature fluctuations, or debris. This first magnet 112 is affixed to the gate 10 using a mounting bracket 110 made from weather-resistant materials such as stainless steel or powder-coated steel, ensuring durability and corrosion resistance. The mounting bracket 110 may feature multiple pre-drilled holes for secure attachment to gates 10 made from materials like wood, metal, or vinyl. Additionally, the mounting bracket 110 offers adjustability, allowing both vertical and horizontal positioning to achieve precise alignment with the second magnet 140, as described more fully below. In one embodiment, the bracket 110 can be in the form of a clamp, a clip, a magnetic bracket, a recessed bracket, or another attachment mechanism, enhancing its versatility for different gate configurations. In one embodiment, the bracket 110 is comprised of an L-shaped bracket or an offset bracket with two 90-degree angles.

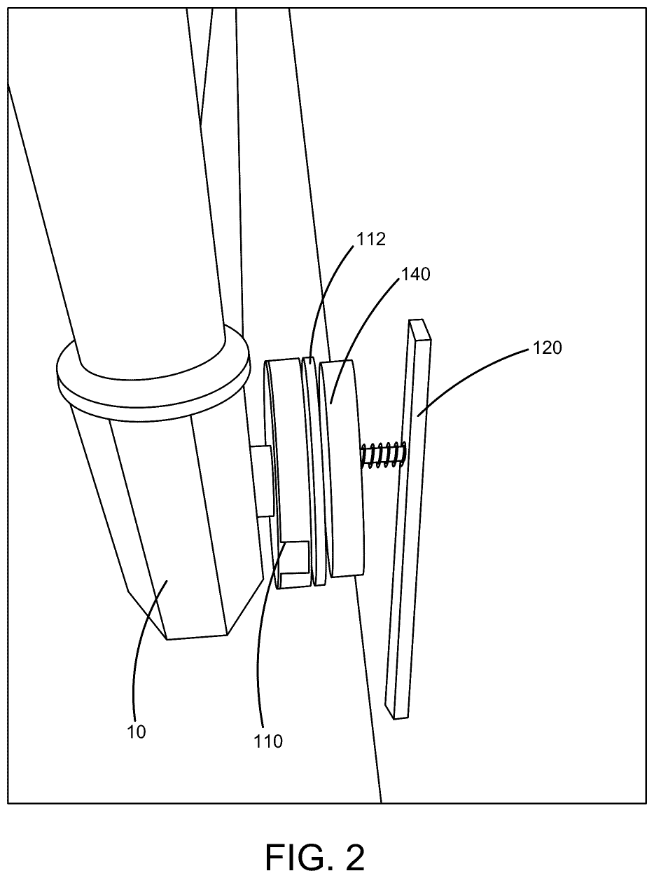

The second component of the device 100 is comprised of at least one second magnet assembly 121, which includes at least one second magnet 140, at least one spring 130, and at least one ground fastener 120. The second magnet 140 is preferably designed to form a secure connection with the first magnet 112 through opposite polarity (as seen in FIG. 2), keeping the gate 10 firmly in the open position when the magnets 112 and 140 are connected. Positioned behind the second magnet 140 is at least one compression-type spring 130. This spring 130 allows the second magnet 140 to retract slightly upon contact with the first magnet 112, serving to absorb impact forces when the gate 10 swings open. By absorbing these forces, the spring 130 reduces mechanical stress on the magnets 112 and 140 and the gate structure. Furthermore, the spring 130 facilitates the disengagement of the magnets with a slight manual pull, ensuring smooth and effortless release of the gate 10.

The second magnet and spring assembly 141 is mounted to a ground fastener 120, which secures the entire assembly 121 to the ground or other surfaces, as seen in FIG. 1 and FIG. 2. The ground fastener 120 is preferably made from heavy-duty galvanized steel to resist corrosion and withstand outdoor conditions. Depending on the installation environment, the ground fastener 120 can be deployed in various ways. For typical outdoor settings, the ground fastener 120 features a pointed spike that can be driven into the soil to ensure secure positioning. In one embodiment, the ground fastener 120 may be telescopic, allowing the height of the second magnet 140 to be adjusted for precise alignment with the first magnet 112 on the gate 10. This telescopic feature ensures reliable performance across different gate heights and varying ground conditions. The height adjustment mechanism can include at least one fastener 122, such as a rotating lock or twisting lock, to securely maintain the desired height of the ground fastener 120.

To operate the gate-securing device 100, the user swings the gate 10 open until the first magnet 112 contacts the second magnet 140. As the gate 10 reaches the fully open position, the spring 130 compresses slightly, establishing a secure magnetic connection between the magnets 112 and 140, as seen in FIG. 2. The gate 10 remains securely held in the open position until it is manually closed. To release the gate 10, a gentle pull disengages the magnets, with the spring 130 providing flexibility to ease the disengagement process. Tension of the spring 130 may be adjusted via at least one fastener 150 such as but not limited to a wing nut.

The gate-securing device 100 offers several advantages, including effective impact absorption through the spring 130, which minimizes mechanical stress and extends the lifespan of the system. The adjustable mounting bracket 110 and ground fastener 120 simplify installation and ensure compatibility with different gate types and ground conditions. Additionally, the use of weather-resistant materials such as stainless steel, powder-coated steel, and galvanized steel enhances the device's durability and reliability in outdoor environments. This design provides a dependable and user-friendly solution for securely holding gates 10 open while reducing the risk of damage caused by unexpected closures.

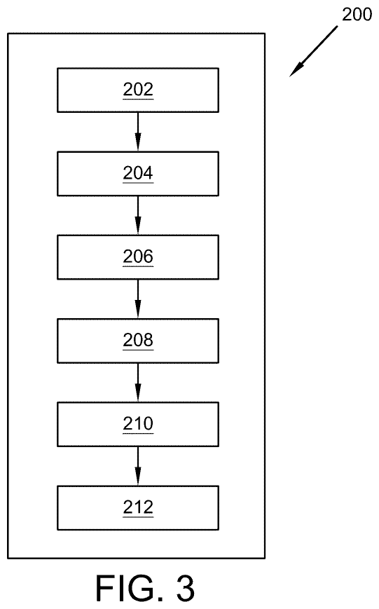

The present invention is also comprised of a method 200 of using the gate-securing device 100, as seen in FIG. 3. First, the gate-securing device 100 is provided comprising at least one first magnet assembly 111, at least one second magnet assembly 121, and at least one ground fastener 120 [Step 202]. Then, the first magnet assembly 111, which includes at least one first magnet 112 and at least one mounting bracket 110, is attached to the gate 10 by securing the mounting bracket 110 to the gate surface [Step 204]. Next, the second magnet assembly 121, which includes at least one second magnet 140 and at least one spring 130, is mounted to the ground fastener 120, and the ground fastener 120 is driven into the ground or secured to another surface such as concrete or a wall [Step 206]. The ground fastener 120 is adjusted to align the second magnet 140 with the first magnet 112 on the gate 10 [Step 208]. Then, the gate 10 is swung open until the first magnet 112 contacts the second magnet 140, causing the spring 130 to compress slightly and create a secure magnetic connection between the magnets 112 and 140 [Step 210]. The gate 10 remains securely held in the open position until manually closed. To release the gate 10, a user can pull the gate 10 to disengage the magnets 112, 140, assisted by the flexibility of the spring 130 [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “gate-securing device” and “device” are interchangeable and refer to the gate-securing device 100 of the present invention.

Notwithstanding the foregoing, the gate-securing device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the gate-securing device 100 as shown in the FIGS. are for illustrative purposes only, and that many other sizes and shapes of the gate-securing device 100 are well within the scope of the present disclosure. Although the dimensions of the gate-securing device 100 are important design parameters for user convenience, the gate-securing device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A gate-securing device comprising:
a first magnet assembly comprising a first magnet and a mounting bracket configured to secure the first magnet to a gate;
a second magnet assembly comprising a second magnet and a spring, wherein the second magnet assembly is configured to secure the second magnet to a ground surface; and
wherein the first magnet and the second magnet are configured to form a magnetic connection to hold the gate in an open position, and wherein the spring is configured to absorb an impact force when the gate swings open.

2. The gate-securing device of claim 1, wherein the ground fastener is comprised of a pointed spike.

3. The gate-securing device of claim 1, wherein the first magnet is comprised of an opposite polarity of the second magnet.

4. The gate-securing device of claim 1, wherein the ground fastener is telescopic to allow for a height adjustment of the second magnet.

5. The gate-securing device of claim 4, wherein the ground fastener is comprised of a fastener for maintaining a desired height.

6. The gate-securing device of claim 5, wherein the fastener is comprised of a rotating lock.

7. The gate-securing device of claim 5, wherein the fastener is comprised of a twisting lock.

8. The gate-securing device of claim 1, wherein the mounting bracket is comprised of a clip.

9. The gate-securing device of claim 1, wherein the mounting bracket is comprised of a clamp.

10. The gate-securing device of claim 1, wherein the mounting bracket is comprised of a magnetic bracket.

11. A gate-securing device comprising:
a first magnet assembly comprising a first magnet and a mounting bracket configured to secure the first magnet to a gate;
a second magnet assembly comprising a second magnet, a compression spring positioned behind the second magnet, and a ground fastener, wherein the second magnet assembly is configured to secure the second magnet to a ground surface;
a ground fastener; and
wherein the first magnet and the second magnet are configured to form a magnetic connection to hold the gate in an open position, and wherein the spring is configured to absorb an impact force when the gate swings open.

12. The gate-securing device of claim 11, wherein the ground fastener is comprised of a pointed spike.

13. The gate-securing device of claim 11, wherein the first magnet is comprised of an opposite polarity of the second magnet.

14. The gate-securing device of claim 12, wherein the ground fastener is telescopic to allow for a height adjustment of the second magnet.

15. The gate-securing device of claim 12, wherein the ground fastener is comprised of a fastener for maintaining a desired height.

16. The gate-securing device of claim 15, wherein the fastener is comprised of a rotating lock.

17. The gate-securing device of claim 15, wherein the fastener is comprised of a twisting lock.

18. The gate-securing device of claim 11, wherein the mounting bracket is comprised of a clip.

19. The gate-securing device of claim 11, wherein the mounting bracket is comprised of a clamp.

20. A method of using a gate-securing device, the method comprising the following steps:
providing a gate-securing device comprised of a first magnet assembly comprised of a mounting bracket and a first magnet, and a second magnet assembly comprising a second magnet, a spring, and a ground fastener;
attaching a first magnet assembly to a gate;
securing the ground fastener to a ground surface;
aligning the second magnet with the first magnet;
swinging the gate open until the first magnet contacts the second magnet, compressing the spring and creating a magnetic connection that holds the gate open; and
releasing the gate by pulling the gate to disengage the magnetic connection, assisted by the flexibility of the spring.
